(19) United States
(12) Patent Application Publication
(10) Pub. No.: US 2003/0130898 A1
(43) Pub. Date: Jul. 10, 2003

(54) System to facilitate electronic shopping

(76) Inventors: Clifford A. Pickover, Yorktown Heights, NY (US); Peter G. Capek, Ossining, NY (US); Paul A. Moskowitz, Yorktown Heights, NY (US); William Grey, Millwood, NY (US)

Correspondence Address: BUCKLEY, MASCHOFF, TALWALKAR, & ALLISON, 5 ELM STREET, NEW CANAAN, CT, 06840, US

(21) Appl. No.: 10/041,176

(22) Filed: Jan. 7, 2002

(51) Int. Cl. G06F 17/60

(52) U.S. Cl. 705/26

(57) ABSTRACT

A system to facilitate electronic shopping operates to associate a set of items with an activity, and, in response to a consumer selection of the activity, to associate the set of items with an electronic shopping cart. According to other aspects, an indication of an activity is transmitted to a consumer, a consumer selection of the activity is received, and, in response to the consumer selection, a set of items is associated with an electronic shopping cart. In still further aspects, an electronic shopping cart is provided, a set of items is associated with an activity, a consumer selection of the activity is received, and, in response to the consumer selection, the set of items is associated with the electronic shopping cart.

### BACKGROUND OF THE INVENTION

1. Field of the Invention

The present invention relates to electronic shopping. Specifically, the present invention concerns electronic shopping systems utilizing electronic shopping carts.

2. Description of the Related Art

Consumers are increasingly turning to the World Wide Web for their shopping needs. Merchants have encouraged and have sought to take advantage of this trend by providing online stores that enable consumers to purchase items such as goods and services. Oftentimes, an online store is an electronic version of a corresponding brick-and-mortar store. For example, the website located at http://www.CircuitCity.com provides an online store that sells items similar to those sold by conventional Circuit City stores. Some merchants, such as Amazon.com, provide online stores for which no brick-and-mortar counterparts exist.

In a typical online store, a consumer browses Web pages provided by a website. The website is operated by a merchant or by an entity that the merchant has employed for this purpose, and the Web pages present descriptions, pictures and prices of items for sale. The Web pages are organized hierarchically according to item type, and are browsed by selecting hyperlinks included therein. Once a consumer identifies an item for purchase, the consumer inputs a command to add the item to his “shopping cart”. This shopping cart is roughly an electronic counterpart to a conventional shopping cart, in that a consumer associates items with the electronic shopping cart and proceeds to “checkout”, where the items associated with the electronic shopping cart are purchased. Once a particular item is associated with an electronic shopping cart, it must be disassociated with the cart in order to purchase other items in the cart without also purchasing the particular item.

Accordingly, association of an item with a shopping cart is a significant step towards the purchase of the item. More specifically, an item must first be associated with a shopping cart before the item may be purchased. Also, due to the extra step required to disassociate an associated item, simply associating an item with a shopping cart increases the possibility that a consumer will purchase the item. Therefore, merchants desire systems that encourage consumers to associate items with electronic shopping carts.

### SUMMARY OF THE INVENTION

In order to address the foregoing, the present invention provides a method, an apparatus, a system, a medium, and means to facilitate electronic shopping in which a set of items is associated with an activity, and, in response to a consumer selection of the activity, the set of items is associated with an electronic shopping cart. By virtue of some embodiments of these features, a consumer may quickly, easily and efficiently add a number of desirable items to an electronic shopping cart. As a result, a consumer may be encouraged to add items to her shopping cart and merchants may sell more items to the consumer than would be sold using conventional systems.

According to other aspects, an indication of an activity is transmitted to a consumer, a consumer selection of the activity is received, and, in response to the consumer selection, a set of items is associated with an electronic shopping cart. In further aspects, an electronic shopping cart is provided, a set of items is associated with an activity, a consumer selection of the activity is received, and, in response to the consumer selection, the set of items is associated with the electronic shopping cart. These aspects may also provide an advantageous system to encourage a consumer to associate items with an electronic shopping cart and to thereby increase online store revenues.

In still other aspects, the present invention provides a method, an apparatus, a system, a medium, and means to facilitate electronic shopping in which it is detected that a consumer has logged on to an online store, and in response to the detection, a set of items is associated with an electronic shopping cart, the electronic shopping cart being associated with the consumer. Embodiments of this aspect allow a merchant, a parent, an employer, or any other entity to “push” a set of items into a consumer's electronic shopping cart, thereby encouraging the consumer to purchase the items.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to facilitate electronic shopping according to embodiments of the present invention.

FIG. 2 is a topographic view of a network architecture according to embodiments of the present invention.

FIG. 3 is a block diagram of an internal architecture of a store server according to embodiments to the present invention.

FIG. 4 is a block diagram of an internal architecture of a consumer device according to embodiments to the present invention.

FIG. 5 is a representative view of a tabular portion of an item database according to embodiments of the present invention.

FIG. 6 is a representative view of a tabular portion of an item set database according to embodiments of the present invention.

FIG. 7 is a representative view of a tabular portion of a shopping cart database according to embodiments of the present invention.

FIG. 8 is a flow diagram of process steps to facilitate electronic shopping according to embodiments of the present invention.

FIG. 9 is a representative view of a display presenting data according to embodiments of the present invention.

FIG. 10 is a representative view of a display presenting data according to embodiments of the present invention.

### DETAILED DESCRIPTION

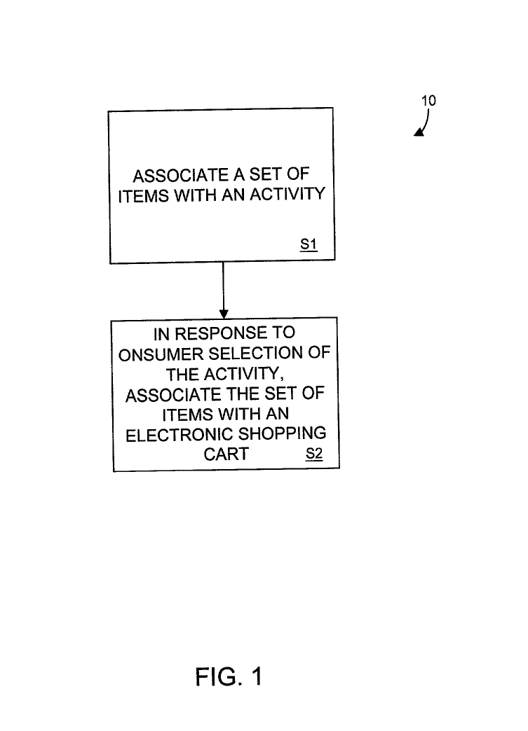

FIG. 1 is a flow diagram of process steps 10 to facilitate electronic shopping according to some embodiments of the present invention. In order to provide an immediate introduction to features of the present invention, process steps 10 will be described with reference to one particular embodiment. Of course, complete descriptions of other specific hardware and software embodiments of the claimed invention are set forth below.

Process steps 10 begin at step S1, in which a set of items is associated with an activity. In the particular embodiment, a merchant associates several camping-related items with the activity “2-person overnight camping”. The set of items includes a 2-person tent, two sleeping bags, a lantern and an outdoor stove. Accordingly, the set of items includes items that might be needed to perform the associated activity.

The set of items is associated with the activity by associating identifiers of each item with a record in a database that is also associated with the activity. In order to determine the set of items to associate with the activity, the merchant may draw on her own experiences, expert advice, another third party, or other sources that will be described in detail below. After step S1, a consumer selects the activity.

In this regard, the activity is presented to the consumer via a Web page provided by the merchant. Specifically, the consumer accesses a website operated by the merchant and browses Web pages transmitted by the website until she locates a selectable indication of the activity. The indication may be any device capable of indicating the activity, such as a picture, icon or text. The consumer selects the activity by selecting the indication, and the selection is transmitted to the merchant.

In response to the selection, the set of items is associated with an electronic shopping cart in step S2. Notably, the electronic shopping cart is also associated with the consumer. The consumer will therefore purchase the set of items if she decides to checkout from the online store after step S2. Process steps 10 thereby provide an efficient system for encouraging a consumer to purchase a number of items using an electronic shopping cart. As mentioned above, more specific features of the invention as well as particular advantages of those features are set forth below.

Network Architecture

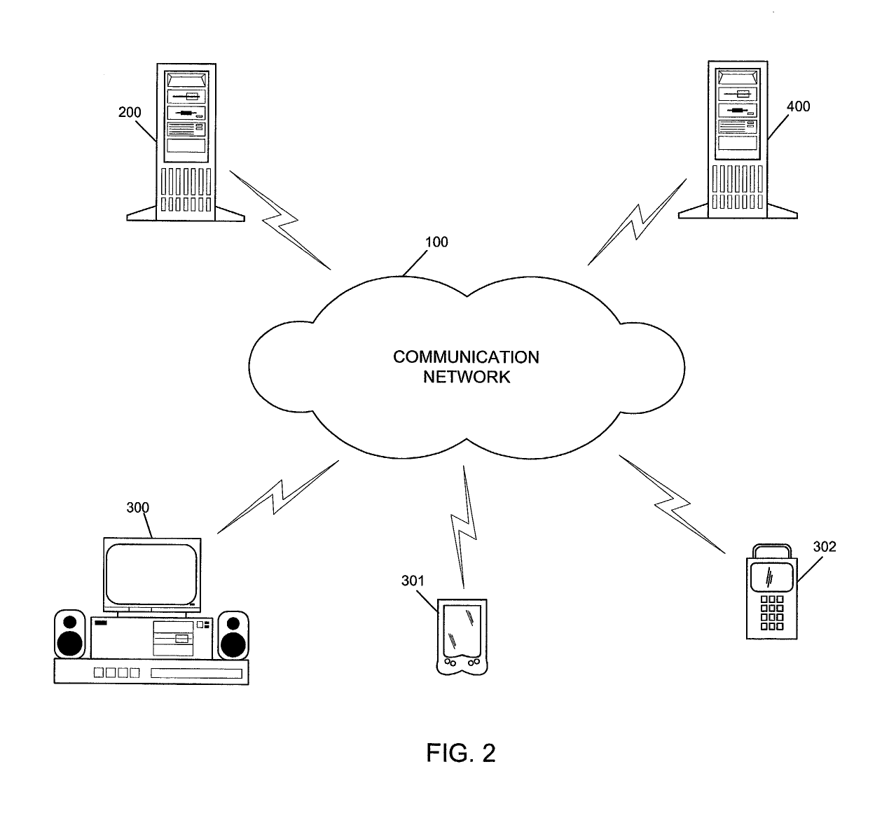

FIG. 2 is a topographic view of a network architecture according to embodiments of the present invention. Of course, network architectures other that that shown in FIG. 2 may be used to implement the invention.

FIG. 2 shows communication network 100 in communication with store server 200, consumer devices 300 to 302 and item set server 400. Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

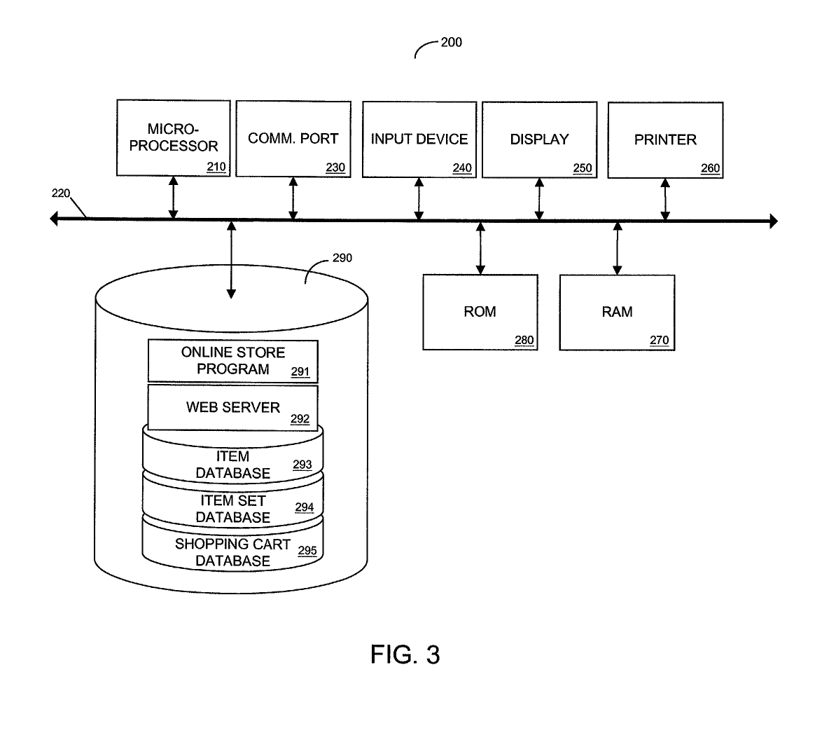

Store server 200 may comprise a Web server, local area network server or other device capable of performing steps according to the present invention. According to some embodiments, store server 200 operates to associate a set of items with an activity, and, in response to a consumer selection of the activity, to associate the set of items with an electronic shopping cart. Store server 200 may also control various operations of an entity providing an online store, such as billing, accounting, sales tracking and the like. It should be noted that store server 200 may also perform functions unrelated to an online store. Details of one embodiment of store server 200 are set forth below with respect to FIG. 3.

Consumer devices 300 to 302 of FIG. 2 comprise a desktop computer, a personal digital assistant (PDA) and a cellular telephone. Any one of consumer devices 300 to 302 may be used by a consumer to select an activity according to embodiments of the invention, in response to which a set of items is associated with an electronic shopping cart. The used consumer device may also be used to purchase the set of items. Accordingly, a consumer device according to the invention may comprise any device or devices for transmitting electronic data over communication network 100. Of course, consumer devices 300 to 302 may also be used by a consumer for other functions, such as word processing, scheduling, e-mail, telephone communication, or the like.

Item set server 400 may be used to provide information based on which store !server 200 associates an activity with a set of items. This information may include complete activity/item set associations that are created by item set server 400 or transmitted thereto by another device, item information, activity information, and consumer information. Item set server 400 may be operated by any entity that collects such information, including the entity operating store server 200.

It should be noted that the elements of FIG. 2 may be connected differently than as shown. For example, some or all of the elements may be connected directly to one another. Of course, embodiments of the invention may include elements that are different from those shown. Moreover, although the illustrated communication links between the components of FIG. 2 appear dedicated, it should be noted that each of the links may be shared by other components. Additionally, elements shown in communication with each other need not be constantly exchanging data. Rather, communication may be established when necessary and severed at other times or always available but rarely used to transmit data.

Store Server

FIG. 3 is a block diagram of the internal architecture of store server 200 according to one embodiment of the invention. As illustrated, store server 200 includes microprocessor 210 in communication with communication bus 220. Microprocessor 210 may be a Pentium™, RISC™, or other type of processor and is used to execute processor-executable process steps so as to control the components of store server 200 to provide functionality according to embodiments of the present invention.

Also in communication with communication bus 220 is communication port 230. Communication port 230 is used to transmit data to and to receive data from devices external to store server 200. Communication port 230 is therefore preferably configured with hardware suitable to physically interface with desired external devices and/or network connections. In one embodiment, selections of activities are received from and electronic shopping carts are presented to consumer devices over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by an entity operating store server 200 to input item information, consumer information, billing information, and other information to store server 200. Of course, such information may also be input to store server 200 via communication port 230. Commands for controlling operation of store server 200 may also be input using input device 240.

Display 250 may be an integral or separate CRT display, a flat-panel display or the like. Display 250 is generally used to output graphics and text to an operator in response to commands issued by microprocessor 210. Printer 260 may also output graphics and text, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, online store program 291 of processor-executable process steps. Microprocessor 210 executes process steps of online store program 291 in order to control store server 200 to operate an online store. For example, the process steps are executed to present items for sale to consumers, to allow consumers to select items, to receive an order for the selected items, and to receive payment in exchange for the items. Moreover, the process steps of online store program 291 may be executed by microprocessor 210 to associate a set of items with an activity, and, in response to a consumer selection of the activity, to associate the set of items with an electronic shopping cart. The process steps may also be executed to detect that a consumer has logged on to an online store, and in response to the detection, to associate a set of items with an electronic shopping cart, the electronic shopping cart being associated with the consumer.

The process steps of online store program 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Process steps of Web server 292 are also stored in data storage device 290 and may be executed to provide a website to a Web client, such as a Web browser executing in consumer device 300. In order to provide a website, Hypertext Transfer Protocol (HTTP) requests are received from a Web client and, in response, appropriate Web pages are created and sent to the Web client. In the example of FIG. 3, the Web pages may be created by one or both of online store program 291 and Web browser 292.

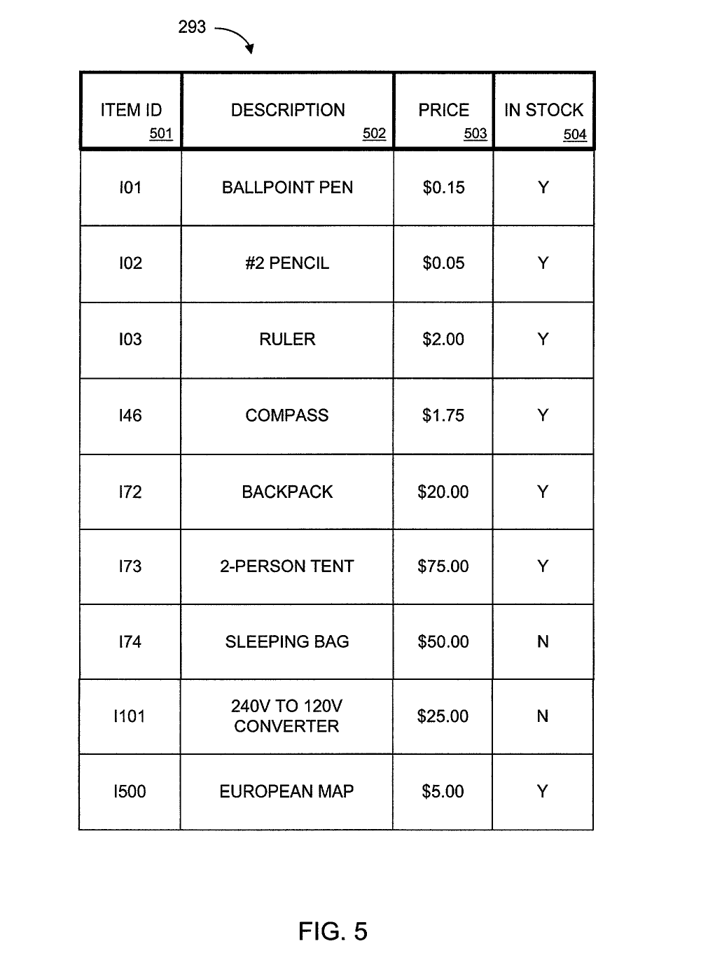

Data storage device 290 also stores item database 293, item set database 294 and shopping cart database 295. Item database 293 stores information regarding items for sale. Such information may include a description, a price, or the like. One example of item database 293 is described below with respect to FIG. 5.

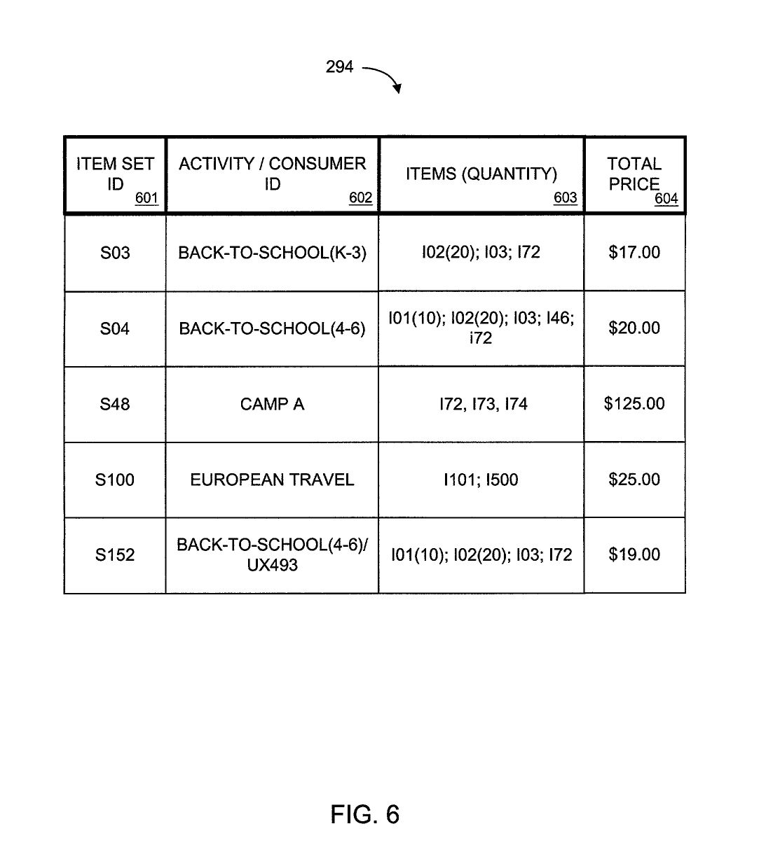

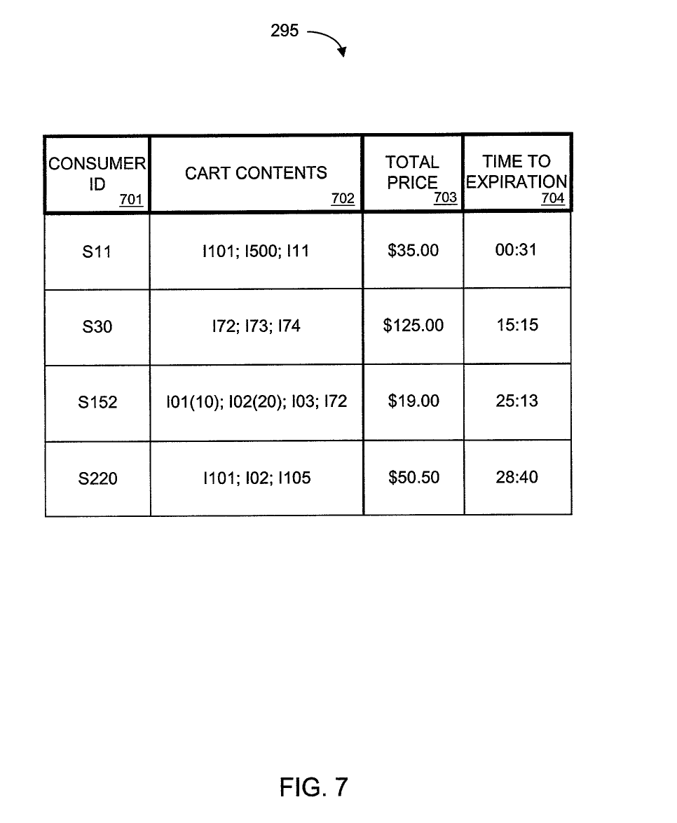

Item set database 294 stores associations between activities and sets of items. Accordingly, the information stored in item set database 294 may be used to determine a set of items to associate with a shopping cart in response to the selection of an activity. The set of items may be associated with the shopping cart by storing an indication of the set in an appropriate record of shopping cart database 295. Representative examples of item set database 294 and shopping cart database 295 are shown in FIG. 6 and FIG. 7, respectively.

Stored in data storage device 290 may also be other unshown elements that may be necessary for operation of store server 200, such as other applications, other data files, a network server, an operating system, a database management system and “device drivers” for allowing microprocessor 210 to interface with devices in communication with communication port 230. These elements are known to those skilled in the art, and are therefore not described in detail herein.

Consumer Device

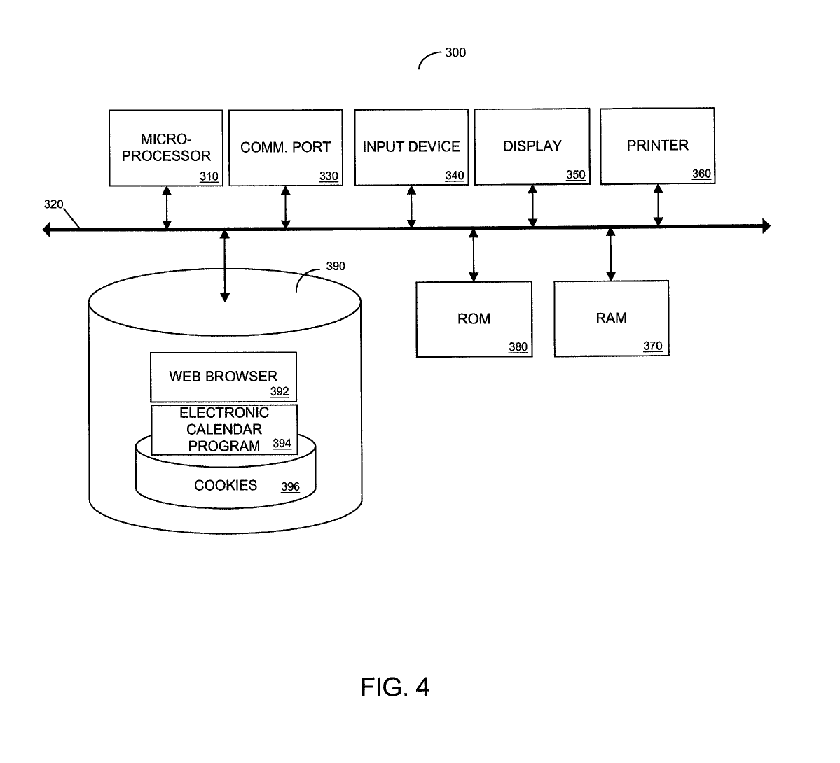

FIG. 4 illustrates several components of consumer device 300 according to embodiments of the invention. The components may comprise any of the specific examples set forth above with respect to identically-named components of store server 200. Of course, specific functions performed by the components may differ from the functions performed by the identically-named components.

In this regard, communication port 330 may be used to transmit requests for information such as Web pages and to receive the information from store server 200. Input device 340 may be used to select activities displayed by the Web pages, to input commands to purchase items associated with a shopping cart, and to output a receipt for the purchase. Such a receipt may be output by display 350 or by printer 360. Input device 340, display 350 and printer 360 may also be used in conjunction with functionality provided by consumer device 300 that is unrelated to the present invention.

Data storage device 390 stores Web browser 392, which is executed by microprocessor 310 and operated by a consumer to access, browse and download information from Web servers supporting HTTP communication.

Also stored in data storage device 390 are processor-executable steps of electronic calendar program 394. The process steps of electronic calendar program 394 may be executed by microprocessor 310 to provide scheduling functionality to a consumer operating consumer device 300. More specifically, the consumer may input her appointment schedule using the program and receive reminders from the program prior to scheduled appointments.

Cookies 396 are also stored in data storage device 390. As is known to those skilled in the art of Web browsers, a cookie is stored on a device by a Web server during a session between the device and the Web server in order to provide identification and other information to the Web server during subsequent sessions with the device. In this regard, a cookie might specify a name of a consumer operating the device, demographic information relating to the consumer, a consumer profile, a list of items purchased by the consumer, etc. Cookies stored among cookies 396 may be used in accordance with the present invention to determine a set of items to associate with an electronic shopping cart. Such a determination will be described below.

Data storage device 390 may also store application files, data files and system files other than those shown in FIG. 4. These files may be used by consumer device 300 to provide various functionalities to a consumer in addition to those provided by the present invention.

Item Database

A tabular representation of a portion of item database 293 is shown in FIG. 5. The information stored in item database 293 may be entered by an operator of store server 200 through input device 240 or may be received from another device such as item set server 400 over communication network 100. The stored information provides details regarding items offered for sale by an online store according to the present invention.

Item database 293 includes several records and associated fields. The fields include item ID field 501, description field 502, price field 503, and in stock field 504. Item ID field 501 of a record represents an item associated with the record that is offered for sale by store server 200, and provides a shorthand notation for referring to the item. Description field 502 provides a description of an item that may be presented to a consumer so that the consumer may identify the item, and price field 503 specifies the retail price of an associated item. In stock field 504 of a record includes a flag specifying whether an item associated with the record is in stock.

Of course, item database 293 may include information in addition to or instead of that shown in FIG. 5. For example, item database 293 may include a path to a photograph of an item, warranty information, manufacturer information, or the like.

Item Set Database

A tabular representation of a portion of item set database 294 is shown in FIG. 6. Item set database 294 includes information that may be used to determine a set of items to associate with an activity according to some embodiments of the present invention. Item set database 294 may also store such associations once they are determined. The stored information may be input by an operator of store server 200 or by a device such as item set server 400.

Each record of item set database 294 includes item set ID field 601, activity/consumer ID field 602, items (quantity) field 603, and total price field 604. Item set ID field 601 of a record includes an identifier specifying a set of items associated with the record. The identifier may be assigned to the set of items by store server 200 when the association is stored in item set database 294 Activity/consumer ID field 602 of a record specifies an activity and/or a consumer associated with a set of items specified in items (quantity) field 603 of the record. Information stored in these fields may be provided by entities other than the operator of store server 200. For example, a school may define a set of items to be associated with the activity “back-to-school (k-3)”. The association may then be transmitted to store server 200 and stored in fields 602 and 603 so that, in response to a consumer selecting the activity “back-to-school (k-3)”, the set of items will be associated with the consumer's electronic shopping cart.

Activity/consumer ID field may be used to provide associations customized to particular consumers. Referring to the record associated with item set ID “S152”, an activity and a consumer ID are specified in field 602. Accordingly, if the specified consumer selects the activity, an electronic shopping cart associated with the consumer may be associated with the items specified in field 603. Activity/consumer ID field 602 may include one or more consumer IDs and no activity, in which case a shopping cart associated with one of the consumers may be associated with a predetermined set of items once it is determined that the consumer has logged on to an online store.

Moreover, the information specified in activity/consumer ID field 602 may include an educational activity, an educational course, travel to a particular political unit, travel to a particular geographic region, travel within a particular terrain, and any activity with which a set of items may be associated. In this regard, an activity and/or consumer ID and set of items to be associated in item set database 294 may be received from and/or defined by another store, a manufacturer, an expert in an activity, a parent or relative of a consumer, an employer of the consumer, a government agency, an educational institution, a camp, an intelligent agent, a merchant, the consumer, or from any other entity.

Item set database 294 may also include other information for determining a set of items to associate with an activity. For example, item set database 294 may associate a set of items with particular consumer preferences, and it may be determined to associate the set of items with an electronic shopping cart of any consumer having the particular preferences. The determination may also be based on a profile of an individual, wherein the individual may be the consumer, a celebrity, a friend of the consumer, or an expert in an activity. In this regard, a consumer's profile and/or preferences may be received from cookies 396 of consumer device 300 during communication with consumer device 300.

Therefore, in cases where item set database 294 associates a set of items with a consumer ID, a consumer profile and/or consumer preferences, the set of items may be associated with an electronic shopping cart in response to detecting that a consumer associated with the ID, profile or preferences has logged on to an online store. Logging on may be detected in any known manner, including by detecting a request from consumer device 300 to access a home page of an online store, by detecting an attempt to access the consumer's online store account or profile using a user name and password, by detecting a successful attempt to access the consumer's online store account or profile, by detecting a request to view contents of an electronic shopping cart, and by detecting a request to access an online store portion of a larger website.

In a specific example of the foregoing, an employer operating item set server 400 transmits identifiers for a set of items to store server 200. The identifiers are transmitted with instructions to associate the identifiers with employees of the employer. The association is stored in item set database 294. Therefore, in response to detecting that an employee of the employer has logged on to the online store, the set of items is associated with an electronic shopping cart that is associated with the employee. Cookies 396 and a stored employee list may be used to determine that the logged-on consumer is an employee of the employer. Of course, other systems may be used to make this determination.

Total price field 604 specifies a price for the items listed in associated items (quantity) field 603. The total price may simply be a sum of retail prices for each item according to price field 503 of item database 293, or may be another price. The total price may reflect a discount off the retail prices as an incentive to purchase the set of items, or may reflect a premium that is added to the retail price charged to consumers in exchange for shopping simplification.

Item set database 294 may of course include information in addition to that shown in FIG. 6. For example, each item specified in items (quantity) field 603 may be associated with a “desirability attribute” indicating item desirability. Possible desirability attributes include: must buy; should buy; optional; and highly recommended. Desirability attributes may also include a recommended quantity.

Shopping Cart Database

FIG. 7 shows a tabular representation of a portion of shopping cart database 295 according to some embodiments of the present invention. Shopping cart database 295 includes information usable to track items associated with electronic shopping carts provided by store server 200.

Specifically, each record in shopping cart database 295 includes consumer ID field 701, cart contents field 702, total price field 703, and time to expiration field 704. Accordingly, each record represents a distinct electronic shopping cart. A record may be created for a consumer once the consumer logs on to an online store associated with shopping cart database 295, or once the consumer chooses to associate an item or items with an electronic shopping cart.

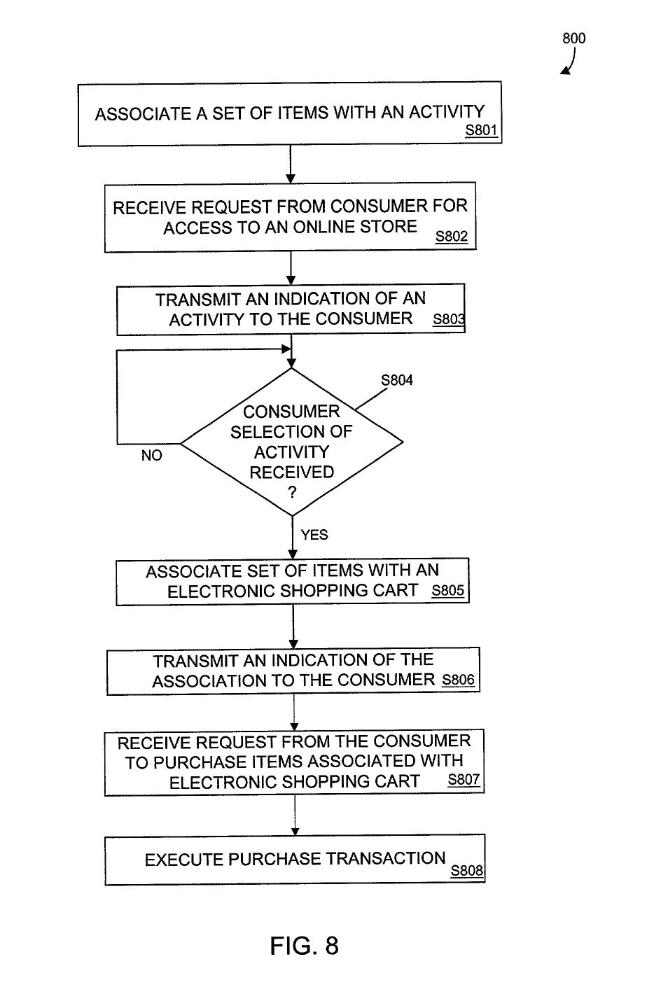

Consumer ID field 701 of a record includes an identifier specifying a consumer with whom the record is associated. The identifier may therefore also be used to identify a shopping cart associated with the consumer. Cart contents field 702 includes identifiers specifying items associated with the shopping cart. The identifiers may be stored in cart contents field 702 in response to consumer selection of an item or in response to consumer selection of an activity. Details of this process are set forth below with respect to FIG. 8.

Total price field 703 specifies a price to be charged to a consumer for all items associated with an associated shopping cart. The total price may be a sum of the retail prices of all items specified in associated cart contents field 702 or may reflect a total price for a set of associated items specified in total price field 604 of item set database 294. Time to expiration field 704 specifies an amount of time until the associated record will be deleted, thereby deleting the associated electronic shopping cart. The amount of time may begin decreasing once the shopping cart is defined in shopping cart database 295. Time to expiration field 704 may be useful in conserving storage capacity because an online store may often experience consumers who associate items with an electronic shopping cart and exit the online store without purchasing the items. Accordingly, a record reflecting this electronic shopping cart need not be maintained.

It is contemplated that each of item database 293, item set database 294 and shopping cart database 295 may include many more records than those shown and that each record may include associated fields other than those illustrated. It should also be noted that the tabular illustrations and accompanying descriptions of the databases merely represent relationships between stored information. A number of other arrangements may be employed besides those suggested.

### SPECIFIC EXAMPLE

Process steps 800 of FIG. 8 set forth a process to facilitate electronic shopping according to an embodiment of the present invention. Process steps 800 are described below as if included in online store program 291 and executed by microprocessor 210 of store server 200. Of course, it should be noted that process steps 800 may be performed by any device or by any number of devices in combination, including consumer device 300 and item set server 400. Moreover, some or all of process steps 800 may be performed manually.

Process steps 800 begin at step S801, in which a set of items is associated with an activity. As described above, the items may be associated with an activity by storing indications of the items and of the activity in fields 602 and 603 of a same record in item set database 294. Step S801 may also include determining the items and the activity to be associated. In this regard, the items and the activity may be determined by and received from an outside source such as item set server 400 or from a consumer device. Of course, the set of items and the activity may also be determined by store server 200.

Next, in step S802, a request is received from a consumer for access to an online store. In some embodiments, the request is transmitted by Web browser 392 executing in consumer device 300. More specifically, a consumer uses input device 340 to input a Uniform Resource Locator (URL) into a window displayed on display 350 by Web browser 392. In response, an IP address corresponding to the URL is retrieved from a Domain Name Server and a request is sent via HTTP to the IP address. According to this example, the IP address corresponds to store server 200, therefore the request is received in step S802 by store server 200.

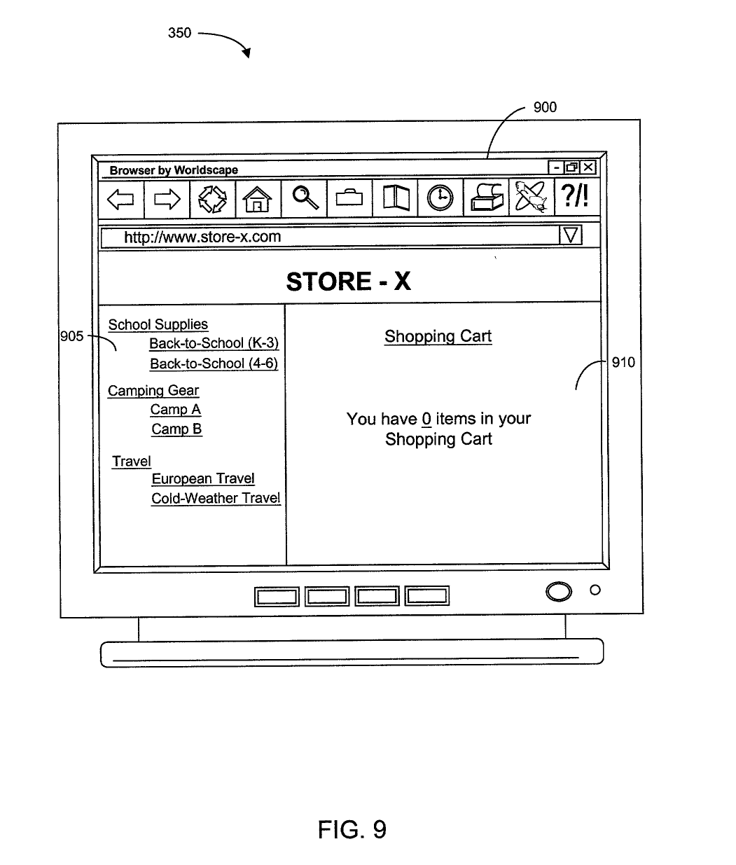

Web server 292 of server 200 receives the request and, in conjunction with online store program 291, creates an appropriate HTML page and transmits the page to consumer device 300. According to step S803, the transmitted page includes an indication of an activity. FIG. 9 shows display 350 presenting such a page. Page 900 includes activity frame 905 and shopping cart frame 910. Activity frame 905 includes text indications of activities that are selectable by the consumer, and shopping cart frame 910 shows a current status of an electronic shopping cart associated with the consumer. In this regard, a record in shopping cart database 295 is created corresponding to the consumer, but at this point cart contents field 702 of the record is unpopulated.

After step S803, process steps 800 pause until it is determined that a consumer selection of an activity has been received. In the present example, the consumer operates input device 340 to select the activity “back-to-school (4-6)” from frame 905 of page 900. The selection is transmitted over communication port 330, is detected in step S804, and flow proceeds to step S805.

A set of items is associated with an electronic shopping cart in step S805. The set of items in the present example is associated with an electronic shopping cart by populating cart contents field 702 of the shopping cart's record with identifiers identifying the set of items. In this regard, step S805 may include determining the set of items to associate with the activity. The determination may be performed simply by identifying the activity in field 602 of a record in item set database 294 and by identifying items from associated items (quantity) field 603. In this case, the set of items may be identical to the set of items associated with the selected activity in step S801.

In some embodiments, the activity is not associated with a set of items until a selection of the activity is received. These embodiments reduce the need to predetermine associations between activities and sets of items, and also allow the associations to be determined on-the-fly based on consumer profile information stored among cookies 396 within consumer device 300.

In stock field 504 may be examined before associating an item with an electronic shopping cart to determine whether the item is in stock. If not, the item is not associated with the cart and the consumer may or may not be notified. In some embodiments, a substitute item is associated in its place.

For purposes of the present example, it is assumed that a cookie was transmitted from cookies 396 to store server 200 sometime between steps S801 and S805. The transmitted cookie identifies the consumer as consumer “UX493”. Accordingly, based on this consumer identifier and the consumer activity selection “back-to-school (4-6)”, a record of item set database is identified in step S805. Item (quantity) field 603 associated with the record is populated with the values “I01(10), I02(20), I03, and I72”. As a result, these values are associated with the record of shopping cart database 295 that corresponds to the consumer's electronic shopping cart.

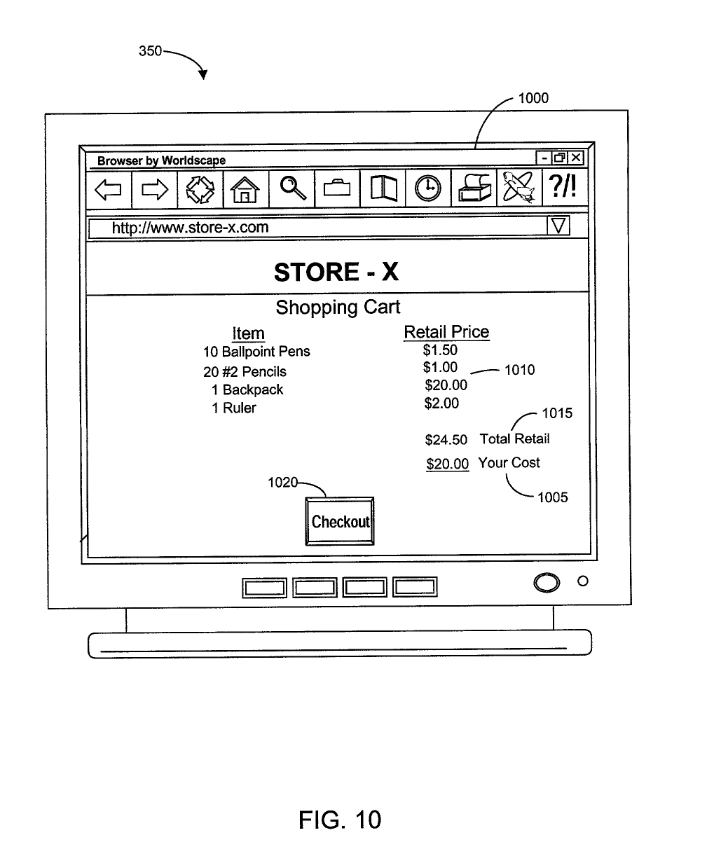

An indication of the association created in step S805 is transmitted to the consumer in step S806. Specifically, an HTML page is created that indicates contents of the electronic shopping cart and the page is transmitted to consumer device 300. FIG. 10 shows page 1000, which indicates contents of the electronic shopping cart according to the present example. As shown, page 1000 also indicates “Your Cost” 1005 based on total price field 604 of the database record corresponding to the shopping cart. Similarly, retail prices 1010 and “Total Retail” 1015 are based on price field 503 of item database 293. In some embodiments, one or more of the associated items is not presented to the consumer until the contents of the shopping cart are purchased. The existence of such a “bonus” item may encourage a consumer to purchase the cart contents.

In some embodiments of step S806, also transmitted to the consumer is an electronic reminder for use with electronic calendar program 394. The electronic reminder may relate to the selected activity. For example, if the selected activity is “European Travel”, the electronic reminder may be a reminder to finalize travel visas one month before the departure date. Accordingly, the reminder will execute during operations of consumer device 300 that are unrelated to the present invention.

Next, the consumer selects “checkout” icon 1020. Selection of the icon generates a request to purchase the items associated with the electronic shopping cart. The request is received in step S807. Accordingly, store server 200 thereafter communicates with consumer device 300 in step S808 to execute a purchase transaction using known methods. However, contrary to known methods, store server 200 may, in step S808 or at any other point of process steps 800, receive offers from vendors to sell one or more of the items to the consumer. These offers may be used to increase profit margins of the entity operating store server 200.

Of course, a system according to the present invention may perform steps different from process steps 800. As explained above, some embodiments omit step S801. Additionally, a consumer may continue shopping after step S806 by returning to page 900 or to another page presented by store server 200. A consumer may also choose to remove one or more of the set of items from the electronic shopping cart prior to purchasing the contents of the cart. In such a case, the consumer may or may not lose any discount represented by the total price of the set of items.

In some embodiments, a consumer may associate a second set of items with an electronic shopping cart by selecting a second activity. A consumer may also be associated with two or more electronic shopping carts, in which case one or more of the shopping carts may be associated with a set of items according to the invention.

In addition, store server 200 may identify duplicates, functional overlaps, or near duplicates between a set of items associated with an electronic shopping cart and other items associated with the shopping cart or otherwise associated with a consumer. If any are identified, they may be disassociated from the electronic shopping cart, and/or the consumer may be notified. Similarly, incompatibilities between associated items may be identified and resolved by notifying the consumer or by disassociating items from the electronic shopping cart.

Using a consumer profile or cookies stored in consumer device 300, it might be determined that one or more of a set of items is already owned by a consumer. In such a case, only those items of the set that are not owned by the consumer are associated with an electronic shopping cart in step S805. Moreover, in some embodiments, items belonging to a set of items that is associated with an electronic shopping cart are presented to the consumer differently than other items in the shopping cart that are not associated according to the present invention. For example, items of the set of items may be presented more or less boldly than the other items, in a similar color, with text indicating their membership in the set of items, or by other known means for differentiating indications of items.

Although the present invention has been described with respect to particular embodiments thereof, those skilled in the art will note that various substitutions may be made to those embodiments described herein without departing from the spirit and scope of the present invention.

What is claimed is:

1. A method to facilitate electronic shopping, comprising:
associating a set of items with an activity; and
in response to a consumer selection of the activity, associating the set of items with an electronic shopping cart.

2. A method according to claim 1, wherein the shopping cart is an online repository for purchases accessed by a device connected to a network.

3. A method according to claim 2, wherein the network is the Internet.

4. A method according to claim 1, wherein the activity is an educational activity.

5. A method according to claim 4, wherein the educational activity is an educational course.

6. A method according to claim 1, wherein the activity is travel to a particular political unit.

7. A method according to claim 1, wherein the activity is travel to a particular geographic region.

8. A method according to claim 1, wherein the activity is travel within a particular terrain.

9. A method according to claim 1, wherein the set of items is determined based on a profile of an individual.

10. A method according to claim 9, wherein the individual is at least one of: the consumer; a celebrity; a friend of the consumer; and an expert in the activity.

11. A method according to claim 1, further comprising:
selling the set of items to the consumer for a first price, the first price reflecting a discount off the individual prices of each of the items.

12. A method according to claim 1, further comprising:
in response to the consumer selection, transmitting reminder information to an electronic calendar or an electronic “to do” list maintained by the consumer.

13. A method according to claim 1, further comprising:
creating a second electronic shopping cart.

14. A method according to claim 1, wherein consumer selection of the activity comprises:
accessing an electronic store providing the electronic shopping cart.

15. A method according to claim 1, wherein at least two of the items are different items.

16. A method according to claim 1, further comprising:
associating a second set of items with the electronic shopping cart.

17. A method according to claim 16, further comprising:
identifying duplicates, functional overlaps or near duplicates between the set of items and the second set of items.

18. A method according to claim 17, further comprising:
disassociating the identified duplicates, functional overlaps, or near duplicates from the electronic shopping cart.

19. A method according to claim 17, further comprising:
notifying the consumer of the identified duplicates, functional overlaps, or near duplicates.

20. A method according to claim 16, further comprising:
identifying incompatibilities between the set of items and the second set of items.

21. A method according to claim 20, further comprising:
resolving the identified incompatibilities.

22. A method according to claim 20, further comprising:
notifying the consumer of the identified incompatibilities.

23. A method according to claim 1, further comprising:
prior to associating the set of items with the electronic shopping cart, determining if the set of items is available for sale at an electronic store providing the electronic shopping cart, and
wherein the set of items is associated with the electronic shopping cart only if it is determined that the set of items is available for sale at an electronic store providing the electronic shopping cart.

24. A method according to claim 1, wherein the set of items is defined by at least one of: a third party; an employer of the consumer; a government agency; an educational institution; a camp; a person related to the consumer; an intelligent agent; a merchant; a Web page; and the consumer.

25. A method according to claim 1, further comprising:
determining that one or more of the set of items are already possessed by the consumer; and
associating only those items of the set of items that are not possessed by the consumer with the electronic shopping cart.

26. A method according to claim 1, wherein a plurality of the items are associated with a desirability attribute.

27. A method according to claim 26, wherein a desirability attribute includes at least one of: must buy; should buy; optional; and highly recommended.

28. A method according to claim 26, wherein a desirability attribute includes a recommended quantity.

29. A method according to claim 1, wherein the identity of one or more of the items is hidden from the consumer until the set of items is purchased by the consumer.

30. A method according to claim 1, further comprising:
receiving offers from vendors to sell one or more of the items to the consumer.

31. A method according to claim 1, wherein the electronic shopping cart is associated with other items, and wherein the items of the set of items are presented to the consumer so as to indicate that the items belong to the set of items and that the other items do not belong to the set of items.

32. A method to facilitate electronic shopping, comprising:
transmitting an indication of an activity to a consumer;
receiving a consumer selection of the activity; and
in response to the consumer selection, associating a set of items with an electronic shopping cart.

33. A method according to claim 1, wherein the set of items is determined based on a profile of an individual.

34. A method according to claim 1, further comprising:
selling the set of items to the consumer for a first price, the first price reflecting a discount off the individual prices of each of the items.

35. A method according to claim 1, further comprising:
in response to the consumer selection, transmitting reminder information to an electronic calendar or an electronic “to do” list maintained by the consumer.

36. A method according to claim 1, wherein consumer selection of the activity comprises:
accessing an electronic store providing the electronic shopping cart.

37. A method according to claim 1, further comprising:
associating a second set of items with the electronic shopping cart.

38. A method according to claim 37, further comprising:
identifying duplicates, functional overlaps or near duplicates between the set of items and the second set of items.

39. A method according to claim 38, further comprising:
disassociating the identified duplicates, functional overlaps, or near duplicates from the electronic shopping cart.

40. A method according to claim 38, further comprising:
notifying the consumer of the identified duplicates, functional overlaps, or near duplicates.

41. A method according to claim 37, further comprising:
identifying incompatibilities between the set of items and the second set of items.

42. A method according to claim 41, further comprising:
resolving the identified incompatibilities.

43. A method according to claim 41, further comprising:
notifying the consumer of the identified incompatibilities.

44. A method according to claim 1, further comprising:
prior to associating the set of items with the electronic shopping cart, determining if the set of items is available for sale at an electronic store providing the electronic shopping cart, and
wherein the set of items is associated with the electronic shopping cart only if it is determined that the set of items is available for sale at an electronic store providing the electronic shopping cart.

45. A method according to claim 1, further comprising:
determining that one or more of the set of items are already possessed by the consumer; and
associating only those items of the set of items that are not possessed by the consumer with the electronic shopping cart.

46. A method according to claim 1, wherein a plurality of the items are associated with a desirability attribute.

47. A method according to claim 46, wherein a desirability attribute includes at least one of: must buy; should buy; optional; and highly recommended.

48. A method according to claim 46, wherein a desirability attribute includes a recommended quantity.

49. A method according to claim 1, wherein the identity of one or more of the items is hidden from the consumer until the set of items is purchased by the consumer.

50. A method according to claim 1, further comprising:
receiving offers from vendors to sell one or more of the items to the consumer.

51. A method according to claim 1, wherein the electronic shopping cart is associated with other items, and wherein the items of the set of items are presented to the consumer so as to indicate that the items belong to the set of items and that the other items do not belong to the set of items.

52. A method to facilitate electronic shopping, comprising:
providing an electronic shopping cart;
associating a set of items with an activity;
receiving a consumer selection of the activity; and
in response to the consumer selection, associating the set of items with the electronic shopping cart.

53. A method to facilitate electronic shopping, comprising:
detecting that a consumer has logged on to an online store; and
in response to the detection, associating a set of items with an electronic shopping cart, the electronic shopping cart being associated with the consumer.

54. A method according to claim 53, wherein the set of items is determined based on a profile of an individual.

55. A method according to claim 54, wherein the individual is at least one of: the consumer; a celebrity; a friend of the consumer; and an expert in the activity.

56. A method according to claim 53, further comprising:
selling the set of items to the consumer for a first price, the first price reflecting a discount off the individual prices of each of the items.

57. A method according to claim 53, wherein the set of items is defined by at least one of: a third party; an employer of the consumer; a government agency; an educational institution; a camp; a person related to the consumer; an intelligent agent; a merchant; a Web page; and the consumer.

58. A method according to claim 53, further comprising:
determining that one or more of the set of items are already possessed by the consumer; and
associating only those items of the set of items that are not possessed by the consumer with the electronic shopping cart.

59. A method according to claim 53, wherein the electronic shopping cart is associated with other items, and wherein the items of the set of items are presented to the consumer so as to indicate that the items belong to the set of items and that the other items do not belong to the set of items.

60. A medium storing processor-executable process steps to facilitate electronic shopping, the process steps comprising:
a step to associate a set of items with an activity; and
a step to, in response to a consumer selection of the activity, associate the set of items with an electronic shopping cart.

61. A medium according to claim 60, wherein the set of items is determined based on a profile of an individual.

62. A medium according to claim 61, wherein the individual is at least one of: the consumer; a celebrity; a friend of the consumer; and an expert in the activity.

63. A medium according to claim 60, the process steps further comprising:
a step to sell the set of items to the consumer for a first price, the first price reflecting a discount off the individual prices of each of the items.

64. A medium according to claim 60, wherein the set of items is defined by at least one of: a third party; an employer of the consumer; a government agency; an educational institution; a camp; a person related to the consumer; an intelligent agent; a merchant; a Web page; and the consumer.

65. A medium according to claim 60, the process steps further comprising:
determining that one or more of the set of items are already possessed by the consumer; and
associating only those items of the set of items that are not possessed by the consumer with the electronic shopping cart.

66. A medium according to claim 60, wherein the electronic shopping cart is associated with other items, and wherein the items of the set of items are presented to the consumer so as to indicate that the items belong to the set of items and that the other items do not belong to the set of items.

67. A medium storing processor-executable process steps to facilitate electronic shopping, the process steps comprising:
a step to transmit an indication of an activity to a consumer;
a step to receive a consumer selection of the activity; and
a step to, in response to the consumer selection, associate a set of items with an electronic shopping cart.

68. A medium according to claim 67, wherein the set of items is determined based on a profile of an individual.

69. A medium according to claim 68, wherein the individual is at least one of: the consumer; a celebrity; a friend of the consumer; and an expert in the activity.

70. A medium according to claim 67, the process steps further comprising:
a step to sell the set of items to the consumer for a first price, the first price reflecting a discount off the individual prices of each of the items.

71. A medium according to claim 67, wherein the set of items is defined by at least one of: a third party; an employer of the consumer; a government agency; an educational institution; a camp; a person related to the consumer; an intelligent agent; a merchant; a Web page; and the consumer.

72. A medium according to claim 67, the process steps further comprising:
a step to determine that one or more of the set of items are already possessed by the consumer; and
a step to associate only those items of the set of items that are not possessed by the consumer with the electronic shopping cart.

73. A medium according to claim 67, wherein the electronic shopping cart is associated with other items, and wherein the items of the set of items are presented to the consumer so as to indicate that the items belong to the set of items and that the other items do not belong to the set of items.

74. A medium storing processor-executable process steps to facilitate electronic shopping, the process steps comprising:
a step to detect that a consumer has logged on to an online store; and
a step to, in response to the detection, associate a set of items with an electronic shopping cart, the electronic shopping cart being associated with the consumer.

75. A medium according to claim 74, wherein the set of items is determined based on a profile of an individual.

76. A medium according to claim 75, wherein the individual is at least one of: the consumer; a celebrity; a friend of the consumer; and an expert in the activity.

77. A medium according to claim 74, the process steps further comprising:
a step to sell the set of items to the consumer for a first price, the first price reflecting a discount off the individual prices of each of the items.

78. A medium according to claim 74, wherein the set of items is defined by at least one of: a third party; an employer of the consumer; a government agency; an educational institution; a camp; a person related to the consumer; an intelligent agent; a merchant; a Web page; and the consumer.

79. A medium according to claim 74, the process steps further comprising:
a step to determining that one or more of the set of items are already possessed by the consumer; and
a step to associate only those items of the set of items that are not possessed by the consumer with the electronic shopping cart.

80. A medium according to claim 74, wherein the electronic shopping cart is associated with other items, and wherein the items of the set of items are presented to the consumer so as to indicate that the items belong to the set of items and that the other items do not belong to the set of items.

81. An apparatus to facilitate electronic shopping, comprising:
a processor; and
a storage device in communication with the processor and storing instructions adapted to be executed by the processor to:
associate a set of items with an activity; and
in response to a consumer selection of the activity, associate the set of items with an electronic shopping cart.

82. An apparatus to facilitate electronic shopping, comprising:
a processor; and
a storage device in communication with the processor and storing instructions adapted to be executed by the processor to:
transmit an indication of an activity to a consumer;
receive a consumer selection of the activity; and
in response to the consumer selection, associate a set of items with an electronic shopping cart.

83. An apparatus to facilitate electronic shopping, comprising:
a processor; and
a storage device in communication with the processor and storing instructions adapted to be executed by the processor to:
detect that a consumer has logged on to an online store; and
in response to the detection, associate a set of items with an electronic shopping cart, the electronic shopping cart being associated with the consumer.
